(19) United States
(12) Patent Application Publication
(10) Pub. No.: US 2013/0183572 A1
(43) Pub. Date: Jul. 18, 2013

(54) LEAD-ACID BATTERY DESIGN HAVING VERSATILE FORM FACTOR

(71) Applicants: Subhash Dhar, Bloomfield Hills, MI (US); William Koetting, Davisburg, MI (US); Kwok Tom, Madison Heights, MI (US); Frank Martin, Rochester Hills, MI (US)

(72) Inventors: Subhash Dhar, Bloomfield Hills, MI (US); William Koetting, Davisburg, MI (US); Kwok Tom, Madison Heights, MI (US); Frank Martin, Rochester Hills, MI (US)

(73) Assignee: Energy Power Systems LLC, Troy, MI (US)

(21) Appl. No.: 13/350,686

(22) Filed: Jan. 13, 2012

(51) Int. Cl. H01M 10/16; H01M 2/02; H01M 2/34; H01M 2/20

(52) U.S. Cl. 429/159

(57) ABSTRACT

An electrochemical cell includes an electrode assembly having a plurality of electrode plates. Each electrode plate includes a current collector having a first portion and a second portion, and each first and second portion having a first surface and a second surface opposing the first surface. The first and second surfaces of the first portion include a positively charged active material, and the first and second surfaces of the second portion include a negatively charged active material. In addition, the plurality of electrode plates includes at least two electrode plates, such that the electrochemical cell is arranged with a first portion of one plate electrochemically connected to a second portion of a second plate.

### RELATED APPLICATIONS

This application incorporates by reference the entire disclosure of U.S. application Ser. No. 13/350,505 entitled, “Improved Substrate for Electrode of Electrochemical Cell,” filed concurrently herewith by Subhash Dhar, et al.

### TECHNICAL FIELD

Embodiments of the present disclosure relate generally to electrochemical cells. More particularly, embodiments of the present disclosure relate to a design of a lead-acid electrochemical cell.

### BACKGROUND

Lead-acid electrochemical cells have been commercially successful as power cells for over one hundred years. For example, lead-acid batteries are widely used for starting, lighting, and ignition (SLI) applications in the automotive industry.

As an alternative to lead-acid batteries, nickel-metal hydride (“Ni-MH”) and lithium-ion (“Li-ion”) batteries have been used for hybrid and electric vehicle applications. Despite their higher cost, Ni-MH and Li-ion electro-chemistries have been favored over lead-acid electrochemistry for hybrid and electric vehicle applications due to their higher specific energy and energy density compared to lead-acid batteries.

While lead-acid, Ni-MH, and Li-ion batteries have each experienced commercial success, conventionally, each of these three types of chemistries have been limited to certain applications. FIG. 18 shows a Ragone plot of various types of electrochemical cells that have been used in automotive applications, depicting their respective specific powers and specific energies compared to other technologies.

Lead-acid battery technology is low-cost, reliable, and relatively safe. Certain applications, such as complete or partial electrification of vehicles and back-up power applications, require higher specific energy than traditional SLI lead-acid batteries deliver. As shown in Table 1, lead-acid batteries suffer from low specific energy due to the weight of the components. Thus, there remains a need for low-cost, reliable, and relatively safe electrochemical cells for various applications that require high specific energy, including certain automotive and back-up power applications.

Lead-acid batteries have many advantages. First, they are a low-cost technology capable of being manufactured in any part of the world. Accordingly, production of lead-acid batteries can be readily scaled-up. Lead-acid batteries are available in large quantities in a variety of sizes and designs. In addition, they deliver good high-rate performance and moderately good low- and high-temperature performance. Lead-acid batteries are electrically efficient, with a turnaround efficiency of 75 to 80%, provide good “float” service (where the charge is maintained near the full-charge level by trickle charging), and exhibit good charge retention. Further, although lead is toxic, lead-acid battery components are easily recycled. An extremely high percentage of lead-acid battery components (in excess of 95%) are typically recycled.

Lead-acid batteries suffer from certain disadvantages as well. They offer relatively low cycle life, particularly in deep-discharge applications. Due to the weight of the lead components and other structural components needed to reinforce the plates, lead-acid batteries typically have limited energy density. If lead-acid batteries are stored for prolonged periods in a discharged condition, sulfation of the electrodes can occur, damaging the battery and impairing its performance. In addition, hydrogen can be evolved in some designs.

In contrast to lead-acid batteries, Ni-MH batteries use a metal hydride as the active negative material along with a conventional positive electrode such as nickel hydroxide. Ni-MH batteries feature relatively long cycle life, especially at a relatively low depth of discharge. The specific energy and energy density of Ni-MH batteries are higher than for lead-acid batteries. In addition, Ni-MH batteries are manufactured in small prismatic and cylindrical cells for a variety of applications and have been employed extensively in hybrid electric vehicles. Larger size Ni-MH cells have found limited use in electric vehicles.

The primary disadvantage of Ni-MH electrochemical cells is their high cost. Li-ion batteries share this disadvantage. In addition, improvements in energy density and specific energy of Li-ion designs have outpaced advances in Ni-MH designs in recent years. Thus, although nickel metal hydride batteries currently deliver substantially more power than designs of a decade ago, the progress of Li-ion batteries, in addition to their inherently higher operating voltage, has made them technically more competitive for many hybrid applications that would otherwise have employed Ni-MH batteries.

Li-ion batteries have captured a substantial share not only of the secondary consumer battery market but a major share of OEM hybrid battery, vehicle, and electric vehicle applications as well. Li-ion batteries provide high-energy density and high specific energy, as well as long cycle life. For example, Li-ion batteries can deliver greater than 1,000 cycles at 80% depth of discharge.

Li-ion batteries have certain advantages. They are available in a wide variety of shapes and sizes, and are much lighter than other secondary batteries that have a comparable energy capacity (both specific energy and energy density). In addition, they have higher open circuit voltage (typically ˜3.5 V vs. 2 V for lead-acid cells). In contrast to Ni—Cd and, to a lesser extent, Ni-MH batteries, Li-ion batteries suffer no “memory effect,” and have much lower rates of self discharge (approximately 5% per month) compared to Ni-MH batteries (up to 20% per month).

Li-ion batteries, however, have certain disadvantages as well. They are expensive. Rates of charge and discharge above 1 C at lower temperatures are challenging because lithium diffusion is slow and it does not allow for the ions to move fast enough. Further, Li-ion batteries use liquid electrolytes to allow for faster diffusion rates, which results in formation of dendritic deposits at the negative electrode, causing hard shorts and resulting in potentially dangerous conditions. Liquid electrolytes also form deposits (referred to as an SEI layer) at the electrolyte/electrode interface, that can inhibit electron transfer, indirectly causing the cell's rate capability and capacity to diminish over time. These problems can be exacerbated by high-charging levels and elevated temperatures. Li-ion cells may irreversibly lose capacity if operated in a float condition. Poor cooling and increased internal resistance cause temperatures to increase inside the cell, further degrading battery life. Most important, however, Li-ion batteries may suffer thermal runaway, if overheated, overcharged, or over-discharged. This can lead to cell rupture, exposing the active material to the atmosphere. In extreme cases, this can cause the battery to catch fire. Deep discharge may short-circuit the Li-ion cell, causing recharging to be unsafe.

To manage these risks, Li-ion batteries are typically manufactured with expensive and complex power and thermal management systems. In a typical Li-ion application for a hybrid vehicle, two-thirds of the volume of the battery module may be given over to collateral equipment for thermal management and power electronics and battery management, dramatically increasing the overall size and weight of the battery system, as well as its cost.

In addition to the differing advantages and disadvantages of lead-acid, Ni-MH and Li-ion batteries, the specific energy, energy density, specific power, and power density of these three electro-chemistries vary substantially. Typical values for systems used in HEV-type applications are provided in Table 1 below.

TABLE 1

| | Specific Energy | | Volumetric Energy | | Specific Power | |
|---|---|---|---|---|---|---|
| Electro-chemistry Type | Density (Whr/kg) | | Density (Whr/l) | | Density (W/kg) | |
| Lead-Acid¹ | 30-50 | Whr/kg | 60-75 | Whr/l | 100-250 | W/kg |
| Nickel Metal | 65-100 | Whr/kg | 150-250 | Whr/1 | 250-550 | W/kg |
| Hydride (Ni-MH)² | | | | | | |
| Lithium-Ion (Li-ion)³ | up to 131 | Whr/kg | 250 | Whr/1 | up to 2,400 | W/kg |

¹http://en.wikipedia.org/wiki/Lead_acid_battery, accessed Jan. 11, 2012.
²Linden, David, ed., Handbook of Batteries, 3^{rd} Ed. (2002).
³http://info.a123systems.com/data-sheet-20ah-prismatic-pouch-cell, accessed Jan. 11, 2012.

Although both Ni-MH and Li-ion battery chemistries have claimed a substantial role in hybrid and electrical vehicles, both chemistries are substantially more expensive than lead-acid batteries for vehicular propulsion assist. The present inventors believe that the embodiments of the present disclosure can substantially improve the capacity of lead-acid batteries to provide a viable, low-cost alternative to Ni-MH and Li-ion electro-chemistries in all types of hybrid and electrical vehicle applications.

In particular, certain applications have proved difficult for Ni-MH and Li-ion batteries, such as certain automotive and standby power applications. Standby power application requirements have gradually been raised. The standby batteries of today have to be truly maintenance free, have to be low-cost, have long cycle-life, have low self-discharge, be capable of operating at extreme temperatures, and, finally, should have high specific energy and high specific power. Emerging smart grid applications to improve energy efficiency require high power, long life, and lower cost for continued growth in the market place.

Automobile manufacturers have encountered substantial consumer resistance in launching fleets of electric vehicles and hybrid vehicles, due to the increased cost of these vehicles relative to conventional automobiles powered by an internal combustion engine (“ICE”). Environmental and energy independence concerns have exerted greater pressures on manufacturers to offer cost-effective alternatives to internal combustion engine-powered vehicles. Although hybrids and electric vehicles can meet that demand, they typically rely on subsidies to defray the higher cost of the energy storage systems.

Table 2 below compares the application of various battery electro-chemistries and the internal combustion engine (ICE) and their current roles in certain automotive applications. As used in Table 2, “SLI” means starting, lighting, ignition; “HEV” means hybrid electric vehicle; “PHEV” means plug-in hybrid electric vehicle; “EREV” means extended range electric vehicle; and “EV” means electric vehicle.

TABLE 2

| | | | Power | | Mild | | | | |
|---|---|---|---|---|---|---|---|---|---|
| | SLI | Start/Stop | Assist | Regeneration | Hybrid | HEV | PHEV | EREV | EV |
| Pb- | ✓ | | | | | | | | |
| Acid | | | | | | | | | |
| Ni- | | | ✓ | ✓ | ✓ | ✓ | | | |
| MH | | | | | | | | | |
| Li- | | | ✓ | ✓ | ✓ | ✓ | ✓ | ✓ | ✓ |
| ion | | | | | | | | | |
| ICE | ✓ | ✓ | ✓ | ✓ | ✓ | ✓ | ✓ | ✓ | |

As shown in Table 2, there remains a need for specific applications in which partial electrification of the vehicle may provide environmental and energy efficiency advantages, without the same level of added costs associated with hybrid and electric vehicles using Ni-MH and Li-ion batteries. Even more specifically, there is a need for a low cost, energy efficient battery in the area of start/stop automotive applications.

Specific points in the duty cycle of an internal combustion engine entail far greater inefficiency than others. Internal combustion engines operate efficiently only over a relatively narrow range of crankshaft speeds. For example, when the vehicle is idling at a stop, fuel is being consumed with no useful work being done. Idle vehicle running time, stop/start events, power steering, air conditioning, or other power electronics component operation entail substantial inefficiencies in terms of fuel economy, as do rapid acceleration events. In addition, environmental pollution from a vehicle at these “start-stop” conditions is far worse than from a running vehicle that is moving. The partial electrification of the vehicle in relation to these more extreme operating conditions has been termed a “micro” or “mild” hybrid application, including start/stop electrification. Micro- and mild-hybrid technologies are unable to displace as much of the power delivered by the internal combustion engine as a full hybrid or electric vehicle. Nonetheless, they may be able to substantially increase fuel efficiency in a cost-effective manner without the substantial capital expenditure associated with full hybrid or full electric vehicle applications.

Conventional lead-acid batteries have not yet been able to fulfill this role. Conventional lead-acid batteries have been designed and optimized for the specific application of SLI operation. The needs of a mild hybrid application are different. A new process, design, and production process need to be developed and optimized for the mild hybrid application.

One need for a mild hybrid application is low-weight battery. Conventional lead-acid batteries are relatively heavy. This causes the battery to have a low specific energy due to the substantial weight of the lead components and other structural components that are necessary to provide rigidity to the plates. SLI lead-acid batteries typically have thinner plates, providing increased surface area needed to produce the power necessary to start the engine. But the grid thickness is limited to a minimum useful thickness because of the casting process and the mechanics of the grid hang. The minimum grid thickness is also determined on the positive electrode by corrosion processes. Positive plates are rarely less than 0.08″ (main outside framing wires) and 0.05″ on the face wires because of the difficulties of casting at production rates and, more importantly, concern over poor cycle-life issues. These parameters limit power. Lead-acid batteries designed for deeper discharge applications (such as motive power for forklifts) typically have heavier plates to enable them to withstand the deeper depth of discharge in these applications.

In addition, in typical lead-acid batteries, the active material is usually formed as a paste that is applied to the grid in order to form the plates as a composite material. Although the paste adheres well to itself, it does not adhere well to the grid materials because of paste shrinkage issues. This requires the use of grids that are more substantial and contain additional structural components to help support the active material, which, in turn, puts an extra weight burden on the cell.

Further, during the manufacture of conventional lead-acid batteries, the components are subjected to a number of mechanical stresses. Pasting active material onto the grid can stress the latticework of the grid. Expanded metal grids are lighter than cast grids, yet, the formation of the expanded grid itself introduces stress at each of the nodes of the expanded grid. These various structural materials, being subjected to substantial mechanical stresses during electrode pasting, handling, and cell operation, tend to corrode more readily in the acid-oxidizing environment of the battery after activation, especially when thin plates are used to increase power.

For example, cast and expanded metal grids have non-uniform stress during the life of the battery due to the molar volume change of converting the lead metal to PbO₂. This volume change of the corrosion product puts huge stress on the grids in a non-uniform manner because of the irregular cross-sectional shapes of the grid wires in cast and expanded metals.

Another need for a mild hybrid application is that rechargeable batteries should be able to be charged and discharged with less than 0.001% energy loss at each cycle. This is a function of the internal resistance of the design and the overvoltage necessary to overcome it. The reaction should be energy-efficient and should involve minimal physical changes to the battery that might limit cycle life. Side chemical reactions that may deteriorate the cell components, cause loss of life, create gaseous byproducts, or loss of energy should be minimal or absent. In addition, a rechargeable battery should desirably have high specific energy, low resistance, and good performance over a wide range of temperatures and be able to mitigate the structural stresses caused by lattice expansion. When the design is optimized for minimum resistance, the charge and discharge efficiency will dramatically improve.

Lead-acid batteries have many of these characteristics. The charge-discharge process is essentially highly reversible. The lead-acid system has been extensively studied and the secondary chemical reactions have been identified. And their detrimental effects have been mitigated using catalyst materials or engineering approaches. Although its energy density and specific energy are relatively low, the lead-acid battery performs reliably over a wide range of temperatures, with good performance and good cycle life. A primary advantage of lead-acid batteries remains their low-cost.

A typical lead-acid electrochemical cell uses lead dioxide as an active material in the positive plate and metallic lead as the active material in the negative plate. These active materials are formed in situ. Typically, a charged positive electrode contains PbO₂. The electrolyte is sulfuric acid solution, typically about 1.2 specific gravity or 37% acid by weight. The basic electrode process in the positive and negative electrodes in a typical cycle involves formation of PbO₂/Pb via a dissolution-precipitation mechanism, causing non-uniform stresses within the positive electrode structure. The first stage in the discharge-charge mechanism is a double-sulfate formation reaction. Sulfuric acid in the electrolyte is consumed by discharge, producing water as the product. Unlike many other electrochemical systems, in lead-acid batteries the electrolyte is itself an active material and can be capacity-limiting.

In conventional lead-acid batteries, the major starting material is highly purified lead. Lead is used for the production of lead oxides for conversion first into paste and ultimately into the lead dioxide positive active material and sponge lead negative active material. Pure lead is generally too soft to be used as a grid material because of processing issues, except in very thick plates or spiral-wound batteries. Lead is typically hardened by the addition of alloying elements. Some of these alloying elements are grain refiners and corrosion inhibitors but others may be detrimental to grid production or battery performance generally. One of the mitigating factors in the corrosion of lead/lead grids is the high hydrogen over-potential for hydrogen evolution on lead. Since most corrosion reactions are accompanied by hydrogen evolution as the cathode reaction, reduced hydrogen evolution may inhibit anodic corrosion as well.

The purpose of the grid is to form the support structure for the active materials and to collect and carry the current generated during discharge from the active material to the cell terminals. Mechanical support can also be provided by non-metallic elements such as polymers, ceramics, and other components. But these components are not electrically conductive. Thus, they add weight without contributing to the specific energy of the cell.

Lead oxide is converted into a dough-like material that can be fixed to grids forming the plates. The process by which the paste is integrated into the grid is called pasting. Pasting can be a form of “ribbon” extrusion. The paste is pressed by hand trowel, or by machine, into the grid interstices. The amount of paste applied is regulated by the spacing of the hopper above the grid or the type of troweling. As plates are pasted, water is forced out of the paste.

The typical curing process for SLI lead-acid plates is different for the positive and negative plates. Typically water is driven off the plate in a flash dryer until the amount of water remaining in the plate is between about 8 to 20% by weight. The positive plate is hydro-set at low temperature (<55 C+/−5 C) and high humidity for 24 to 72 hours. The negative plate is hydro-set at about the same temperature and humidity for 5 to 12 hours. The negative plate may be dried to the lower end of the 8 to 20% range and the positive plate to the upper end of the range. More recently, manufacturers use curing ovens where temperature and humidity are more precisely controlled. In the conventional process steps, the “hydro-set process” causes shrinkage of the “paste” active material that, in turn, causes it to break away from the grid in a non-uniform manner. The grid metal that is exposed is corroded preferentially and, since it is not in contact locally with the active material, results in increased resistance as well as formation, and life issues.

A simple cell consists of one positive and one negative plate, with one separator positioned between them. Most practical lead-acid electrochemical cells contain between 3 and 30 plates with separators between them. Leaf separators are typically used, although envelope separators may be used as well. The separator electrically insulates each plate from its nearest counter-electrode but must be porous enough to allow acid transport in or out of the plates.

A variety of different processes are used to seal battery cases and covers together. Enclosed cells are necessary to minimize safety hazards associated with the acidic electrolyte, potentially explosive gases produced on overcharge, and electric shock. Most SLI batteries are sealed with fusion of the case and cover, although some deep-cycling batteries are heat sealed. A wide variety of glues, clamps, and fasteners are also well-known in the art.

Typically, formation is initiated after the battery has been completely assembled. Formation activates the active materials. Batteries are then tested, packaged, and shipped.

A number of trade-offs must be considered in optimizing lead-acid batteries for various standby power and transportation uses. High-power density requires that the initial resistance of the battery be minimal High-power and energy densities also require the plates and separators be porous and, typically, that the paste density also be very low. High cycle life, in contrast, requires premium separators, high paste density, and the presence of binders, modest depth of discharge, good maintenance, and the presence of alloying elements and thick positive plates. Low-cost, in further contrast, requires both minimum fixed and variable costs, high-speed automated processing, and that no premium materials be used for the grid, paste, separator, or other cell and battery components.

A number of improvements have been made in the basic design of lead-acid electrochemical cells. Many of these have involved improvements in the characteristics of the substrate, the active material, as well as the bus bars or collector elements. For example, a variety of fibers or metals have been added to or embedded in the substrate material to help strengthen it. The active material has been strengthened with a variety of materials, including synthetic fibers and other additions. Particularly with respect to lead-acid batteries, these various approaches represent a trade-off between durability, capacity, and specific energy. The addition of various non-conductive strengthening elements helps strengthen the supporting grid but replaces conductive substrate and active material with non-conductive components.

In order to reduce the weight of the lead-acid electrochemical cells relative to their specific energy, various improvements have been disclosed. One approach has been to coat a light-weight, high-tensile strength fiber with sufficient lead to make a composite wire that could be used to support the grid of the electrode. Robertson, U.S. Pat. No. 275,859 discloses an apparatus for extrusion of lead onto a core material for use as a telegraph cable. Barnes, U.S. Pat. No. 3,808,040 discloses strengthening a conductive latticework to serve as a grid element by depositing strips of synthetic resin. Specifically, Barnes '040 patent discloses a lead-coated glass fiber. These approaches, however, have been unable to produce a material with sufficient properties of high-corrosion resistance and high-tensile strength to be able to fabricate a commercially viable lead-acid battery that can survive chemical attack from the electrolyte.

Blayner, et al., have disclosed further improvements in the composition of the substrate to reduce the weight of the electrodes and to increase the proportion of conductive material. Blayner, U.S. Pat. Nos. 5,010,637 and 4,658,623. Blayner discloses a method and apparatus for coating a fiber with an extruded, corrosion-resistant metal. Blayner discloses a variety of core materials that can include high-tensile strength fibrous material, such as an optical glass fiber, or highly-conductive metal wire. Similarly, Blayner discloses that the extruded, corrosion-resistant metal can be any of a number of metals such as lead, zinc, or nickel.

Blayner discloses that a corrosion-resistant metal is extruded through die. The core material is drawn through the die as the metal is extruded onto the core material. Continuous lengths of metal wire or fiber are coated with a uniform layer of extruded, corrosion-resistant metal. The wire is then used to weave a screen that acts as a substrate for the active material. There are no fusion points at the intersections of the woven wires. The electrode may be constructed using such a screen as a grid with the active material being applied onto the grid. Rechargeable lead-acid electrochemical cells are constructed using pairs of electrodes.

Blayner discloses further improvements regarding the grain structure of the metal coating on the core material. In particular, Blayner discloses that the extruded corrosion-resistant metal has a longitudinally-oriented grain structure and uniform grain size. U.S. Pat. No. 5,925,470 and 6,027,822.

Fang, et al., disclose in their paper, Effect of Gap Size on Coating Extrusion of Pb-GF Composite Wire by Theoretical Calculation and Experimental Investigation, J. Mater. Sci. Technol., Vol. 21, No. 5 (2005), optimizing the gap in extruding lead-coated glass fiber. Although Blayner does not disclose the relationship between gap size and extrusion of the lead coated composite wire, Fang characterizes gap size as a key parameter for the continuous coating extrusion process. Fang reports that a gap between 0.12 mm and 0.24 mm is necessary, with a gap of 0.18 mm being optimal. Fang further reports that continuous fiber composite wire can enhance load and improve energy utilization.

The present inventors have found that, despite improvements in lead-acid electrochemical cells for automotive applications, prior known lead-acid batteries have not been able to achieve the same performance as Li-ion or Ni-MH cells for similar applications. There remains a need, therefore, for further improvements in the design and composition of lead-acid electrochemical cells to meet the specialized needs of the automotive and standby power markets. Specifically, there remains a need for a reliable replacement for lithium-ion electrochemical cells in certain applications that do not entail the same safety concerns raised by Li-ion electrochemical cells. Similarly, there remains a need for a reliable replacement for Ni-MH and Li-ion electrochemical cells with the added benefits of low-cost and reliability of lead-acid electrochemical cells. In addition, there remains a need for substantial improvement in battery production capacity to meet the growing needs of the automotive and standby power segments.

The United States Department of Energy (USDOE) has issued Corporate Average Fuel Efficiency (CAFE) guidelines for automotive fleets. Previously, SUVs and light trucks were excluded from the CAFE averages for motor vehicles. More recently, however, integrated guidelines have emerged specifying fuel efficiency standards for passenger vehicles, light trucks, and SUVs. These guidelines require an average fuel efficiency of 31.4 miles per gallon by 2016. http://www.epa.gov/oms/climate/regulations/420r10009.pdf.

Anticipated improvements in internal combustion engine technology do not appear to be able to reach this goal. Similarly, the manufacturing capacity for pure hybrids and pure electric vehicles does not appear sufficient to be able to reach this goal. Thus, it is anticipated that some combination of micro-hybrids or mild hybrids, in which electrochemical cells provide some of the power for either stop/start or certain acceleration applications, will be necessary in order to meet the CAFE standards.

Lead-acid battery systems may provide a reliable replacement for Li-ion or Ni-MH batteries in these applications, without the substantial safety concerns associated with Li-ion electrochemistry and the increased cost associated with both Li-ion and Ni-MH batteries.

Further, the improved batteries of the present invention may be combined in hybrid systems with other types of electrochemical cells to provide electric power that is tailored to the unique automotive application. For example, a lead-acid battery of the present invention which features high-power can be combined with a Lithium-ion (“Li-ion”) or Nickel metal hydride (“Ni-MH”) electrochemical cell offering high energy, to provide a composite battery system tailored to the needs of the particular automotive standby or stationary power application, while reducing the relative sizes of each component.

### SUMMARY

An aspect of the present disclosure includes an electrochemical cell having an electrode assembly, wherein the electrode assembly may include a plurality of electrode plates. Each electrode plate may include a current collector having a first portion and a second portion, and wherein each first and second portion may have a first surface and a second surface opposing the first surface. The first and second surfaces of the first portion may include a positively charged active material, and the first and second surfaces of the second portion may include a negatively charged active material. The plurality of electrode plates may include at least three electrode plates, such that the electrochemical cell may be arranged with a first portion of one plate of the at least three electrode plates electrochemically connected to a second portion of a second plate of the at least three electrode plates, and a first portion of the second plate of the at least three electrode plates electrochemically may be connected to a second portion of a third plate of the at least three electrode plates.

In various embodiments, the electrochemical cell may include the following features, either alone or in combination: each electrode plate may include a plurality of electrode connectors connecting the first portion to the second portion; each electrode plate may include shunt current mitigating means; the current collector may include a uniform current density; a first separator may be attached to the first surface of the first portion and a second separator may be attached to the first surface of the second portion; a plurality of electrode assemblies may be stacked in series for building voltage; an insulator may be connected to the top electrode plate, and the insulator may include at least one slit therein with an electrode plate extending there through; the electrochemical cell may be a lead-acid electrochemical cell; the electrode assembly may be connected to tabs; at least two electrode assemblies may be stacked in parallel for building capacity; there may be at least one power bus assembly including at least one bolt for building capacity; at least two of the electrode plates may be electrochemically connected at a ninety degree angle relative to one another; and the electrochemical cell may include a cross-sectional shaped selected from one of circular, rectangular, square, L-shaped, or U-shaped.

Additional objects and advantages of the disclosure will be set forth in part in the description which follows, and in part will be apparent from the description, or may be learned by practice of the disclosure. The objects and advantages of the disclosure will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one embodiments of the disclosure and together with the description, serve to explain the principles of the disclosure.

### BRIEF DESCRIPTION OF THE DRAWINGS

FIG. 1 is a schematic isometric view of a portion of a lead-acid electrochemical cell showing a plurality of electrode assemblies connected in a spiral configuration according to an embodiment of the present disclosure.

FIG. 2A is a schematic isometric view of a portion of an electrode assembly according to an embodiment of the present disclosure.

FIG. 2B is an exploded isometric view of a portion of the electrode assembly of FIG. 2A.

FIGS. 3A and 3B are side views of the electrode assembly of FIG. 2A.

FIG. 4A is a schematic top view of an electrode plate of the electrode assembly of FIG. 2A.

FIG. 4B is an exploded isometric view of the electrode plate of FIG. 4A with accompanying separator and pasting papers.

FIG. 5 is a schematic top view of an alternative embodiment of an electrode plate of the electrode assembly of FIG. 2A depicting the current collector.

FIG. 6 is an exploded isometric view of a lead-acid electrochemical cell module and package according to an embodiment of the present disclosure.

FIG. 7 is a schematic isometric view of a plurality of electrode assemblies connected in a spiral configuration according to another embodiment of the present disclosure.

FIG. 8 is an exploded isometric view of a portion of an electrode assembly of the lead-acid electrochemical cell of FIG. 7.

FIG. 9 is an exploded isometric view of a portion of a lead-acid electrochemical cell module according to another embodiment of the present disclosure.

FIG. 10 is a schematic isometric view of two stacked lead-acid electrochemical cell modules of FIG. 9 connected in series.

FIG. 11 is a schematic isometric view of an electrode plate according to another embodiment of the present disclosure.

FIG. 12 is an exploded isometric view of a partial electrode assembly according to another embodiment of the present disclosure.

FIG. 13 is a schematic isometric view of a portion of a lead-acid electrochemical cell with a plurality of electrode assemblies in a stacked configuration according to another embodiment of the present disclosure.

FIG. 14 is a schematic isometric view of the lead-acid electrochemical cell of FIG. 13 connected to a power bus.

FIG. 15 is an exploded isometric view of the power bus of FIG. 14.

FIG. 16 is an exploded isometric view of a partial lead-acid electrochemical cell module, power bus, and package according to another embodiment of the present disclosure.

FIG. 17 is a schematic isometric view of a lead-acid electrochemical cell with a plurality of electrode assemblies in a stacked configuration according to another embodiment of the present disclosure.

FIG. 18 shows a Ragone plot of various types of electrochemical cells.

### DETAILED DESCRIPTION

Reference will now be made in detail to exemplary embodiments of the present disclosure, examples of which are illustrated in the accompanying drawings. Wherever possible, the same reference numbers will be used throughout the drawings to refer to the same or like parts.

Embodiments of the present disclosure generally relate to a design of a lead-acid electrochemical cell. Lead-acid electrochemical cells typically are in the form of stacked plates with separators between the plates. Accordingly, embodiments of the present disclosure relate to improved stacking of electrode plates in a variety of form factors. The improved stacking and variety of form factors of the lead-acid electrochemical cell design may enable lead-acid electrochemical cells to be used as part of lead-acid batteries, which, in turn, may be used in automobiles to aid in increasing fuel efficiency.

More specifically, embodiments of the present disclosure may include improvements to the design of a lead-acid electrochemical cell which may include improvements to the orientation of electrode plates as well as improvements for mitigating shunt currents. The improvements may result in a lead-acid electrochemical cell that may have a higher voltage while maintaining a lower weight and size. Alternatively, it also enables production of cells having higher capacity at the same relative voltage.

Embodiments of the present disclosure may allow for the use of lead-acid batteries in micro and mild-hybrid applications of vehicles, either alone or in combination with Ni-MH or Li-ion batteries. It should be emphasized, however, that embodiments of the present disclosure are not limited to transportation and automotive applications. Embodiments of the present disclosure may be of use in any area known to those skilled in the art where use of lead-acid batteries is desired, such as stationary power uses and energy storage systems for back-up power situations. Further, the present inventors intend that the elements or components of the various embodiments disclosed herein may be used together with other elements or components of other embodiments.

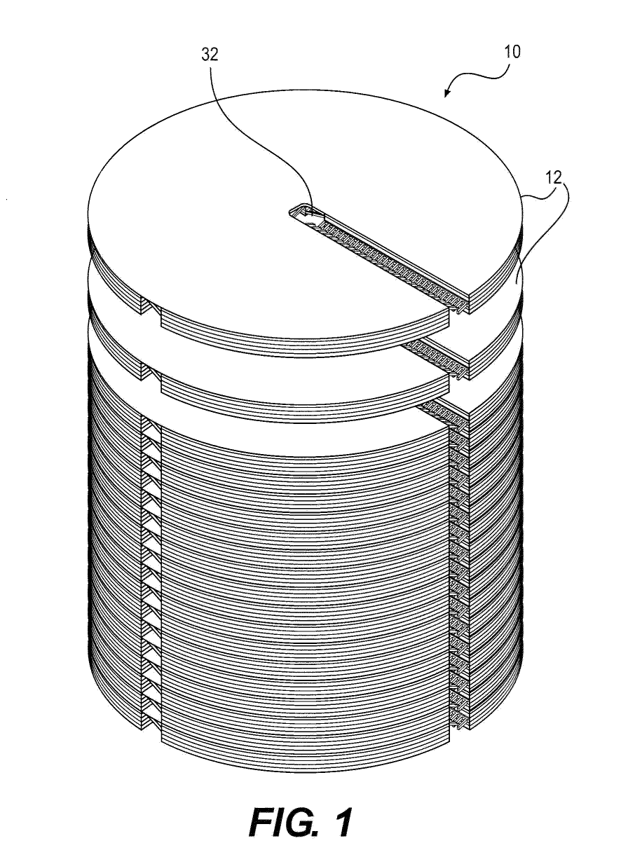

FIG. 1 depicts a lead-acid electrochemical cell 10 according to a first embodiment of the present disclosure. The lead-acid electrochemical cell 10 may include a plurality of electrode assemblies 12. Each electrode assembly 12 may include a plurality of electrode plates positioned in electrochemical contact with each other. The electrode assemblies 12 may be connected in a spiral configuration to build voltage within the lead-acid electrochemical cell. In particular, the spiral configuration may enable a lead-acid electrochemical cell to build voltage while maintaining constant capacity. The number of electrode assemblies that make up the spiral configuration, as well as the configuration of each electrode assembly, may vary depending on the desired shape and desired voltage of the lead-acid electrochemical cell.

In addition, as shown in FIG. 1, the spiral configuration may have an opening 32 formed in the center of the stacked electrode assemblies, by virtue of the shapes of electrode assemblies 12. The central opening 32 may extend through the entire spiral configuration, forming a central bore allows for the main positive and negative leads to run through each electrode assembly 12 and be connected to the top of the spiral configuration.

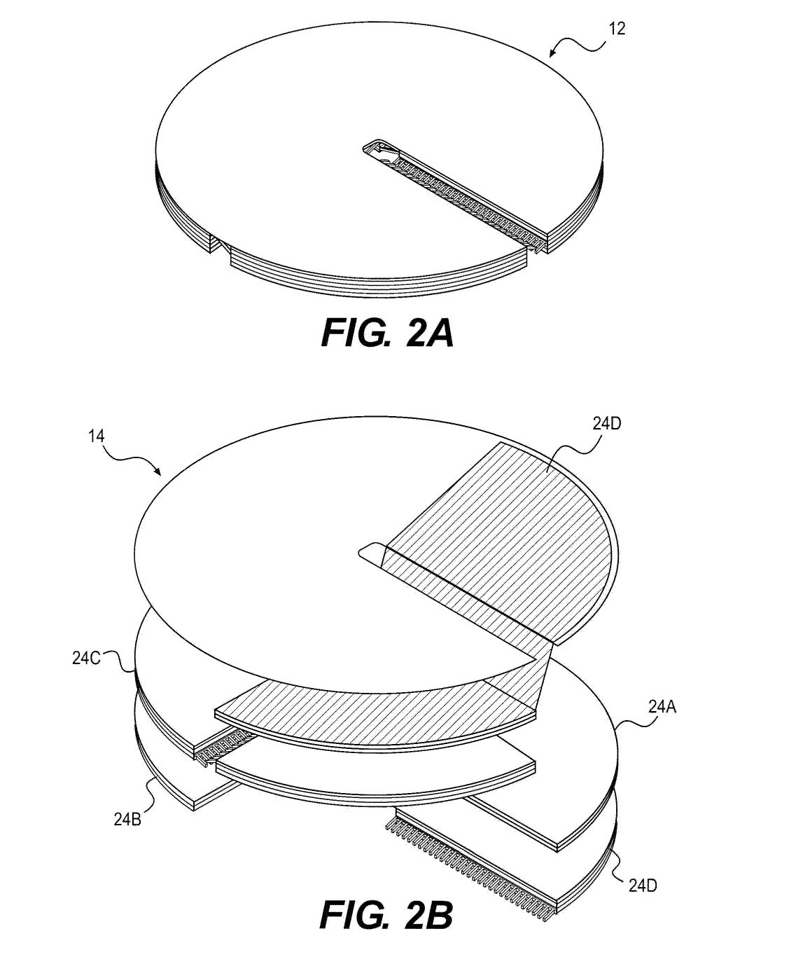

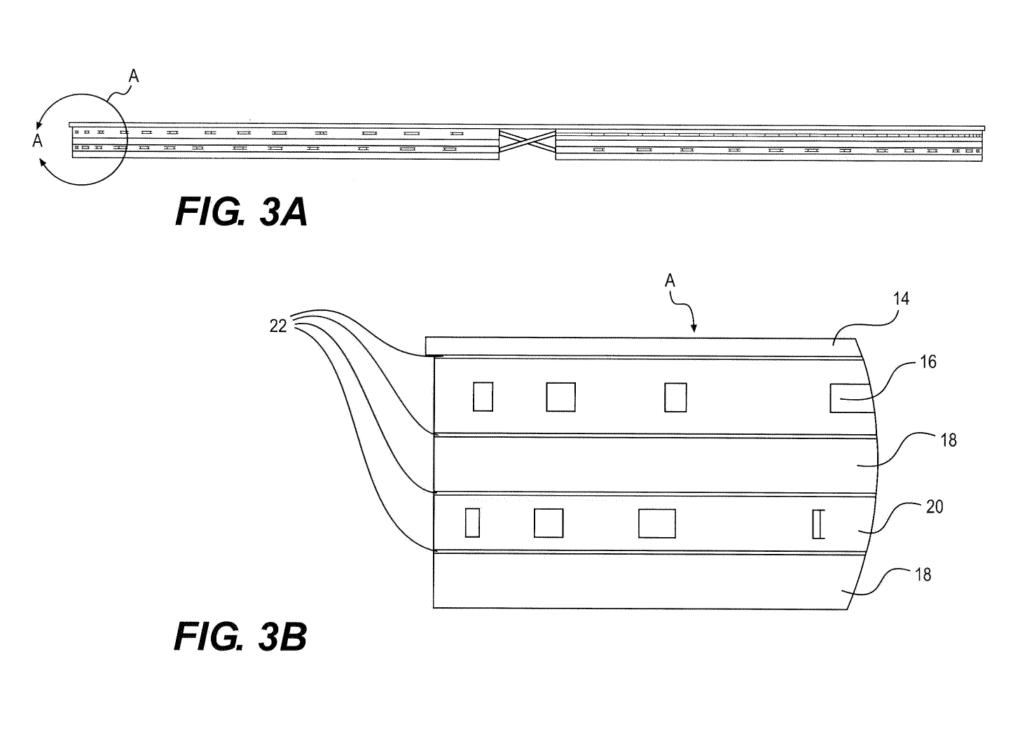

Each electrode assembly 12 in the lead-acid electrochemical cell may be separated by an insulator 14 (FIG. 2B). The insulator may be the cross-sectional shape of the electrode assembly and may include a radial slit 15. For example, in the embodiment of FIG. 1, the cross-sectional shape of each electrode assembly 12 may be semi-circular. Accordingly, the insulator 14 may include a circular shape and a slit 15 along a radius. As shown in FIG. 2B, the insulator 14 may further include a bottom surface and a top surface. Further, each electrode assembly 12 may include multiple electrode plates 24 with a top plate 24D in contact with both the top and bottom surfaces of insulator 14. For example, as shown in FIG. 2B, the top plate 24D of one electrode assembly may include a first portion in contact with the bottom surface of the insulator, and a second portion in contact with the top surface of the insulator. The spiral configuration of the lead-acid electrochemical cell may be achieved by connecting the second portion of the top electrode plate 24D in one electrode assembly 12 to the first portion of a bottom electrode plate 24A in another electrode assembly 12.

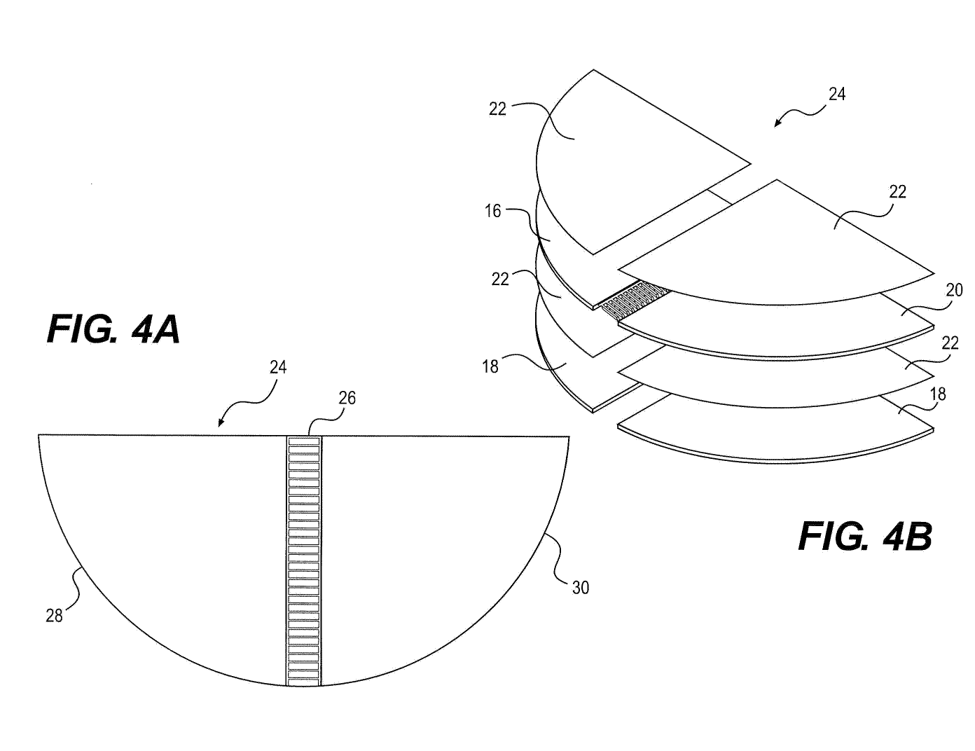

FIG. 2A and FIG. 2B of the present disclosure depict schematic views of an electrode assembly 12 of the lead-acid electrochemical cell of FIG. 1. As shown in FIG. 2B, the electrode assembly may include four electrode plates 24A-D. Each electrode plate may be in the shape of half of a semi-circular section, as shown in FIG. 4A and FIG. 4B.

As shown in FIG. 4A, each electrode plate 24 may include a first portion 28 and a second portion 30. The first and second portions 28, 30 may be connected by a plurality of electrode connectors 26. Each portion may include a substrate, which may be a current collector (not shown). As described above, the electrode substrate may be of the type disclosed in U.S. application Ser. No. 13/350,505 for Improved Substrate for Electrode of Electrochemical Cell, filed concurrently herewith by Subhash Dhar, et al., the entire disclosure of which is incorporated herein by reference.

Thus, the substrate may include a grid-like structure formed of conductive material, with spaces there between for supporting active material. Accordingly, the substrate may include a sheet of material having aligned dimple-like spaces or a plurality of through-holes in linear patterns. Alternatively, the substrate may include a plurality of pieces of material, such as wires, woven together to form a mesh. In a further embodiment, the substrate may include an expanded sheet of material with holes there through. The substrate may include material that may result in an increased adhesion between the substrate and the active material, as well as increased surface conductivity and reduced corrosion of the electrode plate.

As shown in FIGS. 4A and 4B, the positive and negative portions of each electrode plate are depicted as 90° sections. It will be apparent to persons of ordinary skill in the art that sections of various alternative geometries may be employed, without departing from the scope or spirit of the invention as claimed. For example, sections could be 30°, or 45°, 60°, or any other appropriate geometry. If 90° sections are employed, four pairs of positive and negative electrodes may comprise each layer; if 60° sections are employed, 6 pairs; if 45° sections are used, 8 pairs; if 30° sections are used, 12 pairs; and so forth. Persons of ordinary skill will appreciate that, as the number of sections per layer increases, the area of the active material in each section decreases, proportionately, at a constant radius. This decrease can be offset by increasing the radius of the electrode to provide more active material surface area as the number of sections increases.

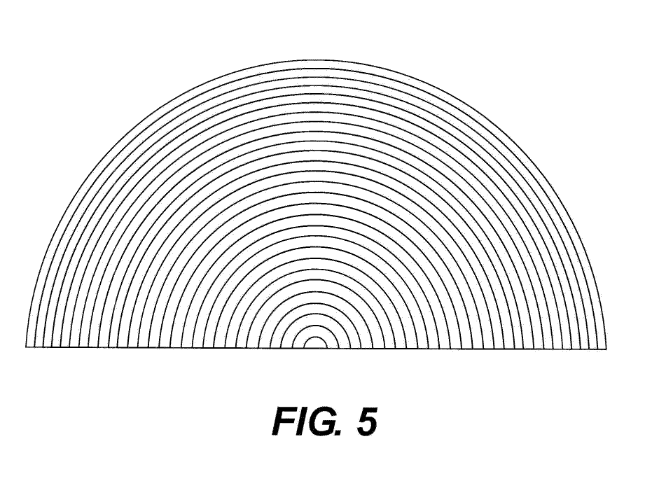

The substrate may further be formed such that a relatively constant current density may be maintained throughout each electrode plate. For example, in the first embodiment of the electrode plate of FIG. 4A, the electrode plate 24 may include a substantially semi-circular shape. Accordingly, the substrate of the electrode plate 24 may include a substantially semi-circular shape as well. Constant current density throughout the substrate may be achieved by spacing the current collector elements of the substrate closer together in the radial direction at the outer radius of the electrode plate than at the inner diameters, and farther apart at the inner radial extent of the plate, as shown in FIG. 5.

The active material may be placed onto each portion of the substrate such that a pseudo bi-polar electrode plate may be formed. The pseudo bi-polar design may be accomplished by disposing both positive and negative active materials in alternating fields on a common substrate. In one embodiment, for example, the pseudo bi-polar design may include placing positive active material onto the first portion 28 of the substrate; and placing negative active material onto the second portion 30 of the substrate. This pseudo bi-polar design may offer lower resistance and higher power of the lead-acid electrochemical cell. Further, it may enable the lead-acid electrochemical cell to operate at a lower temperature, which may reduce the need for collateral cooling equipment. As shown in FIG. 4A and FIG. 4B, the first portion 28 of each electrode plate 24 may be positive 16, and the second portion 30 of each electrode plate 24 may be negative 20, with the electrode connectors 26 between the negative and positive regions of the electrode plate.

Each positive portion 16 and negative portion 20 of each electrode plate may further include a top surface and a bottom surface. As shown in FIG. 4B, a thin layer of pasting paper 22 may be disposed on the top and bottom surfaces of each portion of the electrode plate. Additionally, a separator 18 may be disposed adjacent the pasting paper on the bottom surface of each portion.

As previously disclosed, each electrode assembly 12 may include four electrode plates 24A-D as shown in FIGS. 2A and 2B. The electrode assembly 12 may be formed by stacking each plate 24 at a ninety degree angle relative to one another such that a positive portion 16 of one plate may be connected to a negative portion 20 of another plate. In one embodiment, for example, a first electrode plate 24A having a positive portion 16 and a negative portion 20 may be the bottom plate of the electrode assembly. A second electrode plate 24B having a positive portion 16 and a negative portion 20 may then be stacked onto the first electrode plate 24A. This may be accomplished by turning the second electrode plate 24B ninety degrees relative to the first electrode plate and placing the positive portion 16 of the second plate 24B on top of the negative portion 20 of the first plate 24A (FIG. 2B). A third electrode plate 24C having a positive portion 16 and a negative portion 20 may be stacked upon the second plate 24B in the same manner as previously discussed; and a fourth electrode plate 24D may then be stacked upon the third electrode plate 24C. The fourth electrode plate 24D may be the top electrode plate of the electrode assembly 12 (FIG. 2B).

Upon placement of the fourth electrode plate 24D, insulator 14 may be placed on the electrode assembly. As previously discussed, and shown in FIG. 2B, the positive portion 16 of the fourth, i.e., top electrode plate 24D may be connected to the negative portion 20 of the third electrode plate 24C. The insulator 14, including the slit 15, may be placed on the electrode assembly such that the top of positive portion 16 of the fourth plate 24D may be in contact with the bottom surface of the insulator 14, and the bottom of the negative portion 20 of the fourth plate 24D may be in contact with the top surface of the insulator 14. Accordingly, the negative portion 20 of the fourth plate 24D may be stacked with a free, positive portion 16 of a first plate 24A of another electrode assembly 12, which may thereby form the spiral configuration of the lead-acid electrochemical cell shown in FIG. 1.

Alternatively, the electrode assembly may be formed such that the free portion of the fourth plate 24D is a positive portion and the free portion of the first plate 24A is a negative portion. In addition, the free portion of the fourth plate 24D of the top electrode assembly in the spiral configuration may be connected to a single portion plate in order to complete the circuit. In an alternative embodiment, the top plate 24D of the top electrode assembly may only be a single portion plate, thereby completing the circuit with the connection to the third plate 24D.

The pseudo bi-polar design of each electrode plate may allow for the spiral configuration to build voltage in the lead-acid electrochemical cell to any desired value (e.g., 24V, 36V, 42V, or 48V) at a constant capacity, while maintaining a low weight of the lead-acid electrochemical cell. The low weight may be due to the sizes of the components of the electrode assembly, as well as the material-make up of each electrode plate. In addition, the stacking of the electrode plates at a ninety degree angle relative to one another may allow for thinner components. For example, in one embodiment, the electrode assembly 12 may include a diameter of about 8 inches and may be about 0.3 inches thick. More specifically, the positive portion 16 of the electrode may be about 0.082 inches thick; the negative portion 20 of the electrode may be about 0.06 inches thick; the separators 18 may be about 0.06 inches thick; and the pasting paper 22 may be about 0.004 inches thick.

Persons of ordinary skill in the art will understand that stacking of the electrode plates may be accomplished in any of a variety of ways. For example, the plates can be stacked so that the plates build, one upon the other, in a step-wise manner with each positive 16 and negative 20 portion and their accompanying connections 26, lying in the same plane, as shown in FIG. 2. Alternatively, connectors 26 may be angled so that they are offset by the thickness of a plate, pasting papers and separator, to facilitate the rise in the plates as they are stacked. As a further alternative, the electrode plates can be formed having a helical geometric shape, to facilitate stacking the plates in a helical pattern, mitigating step discontinuities and reducing stresses on the connector 26.

The lead-acid electrochemical cell may further include means for mitigating shunt currents due to leakage of electrolyte fluid from the electrodes and separators onto the electrode connectors, which may cause the electrodes to self-discharge. In one embodiment, the electrode connectors 26 and inner portion of a container proximate the electrode plates may be treated with a hydrophobic coating, which may prevent excess electrolyte fluid from wetting the electrodes, or electrode connectors 26, or casing. In other alternative embodiments, the electrode connectors 26 may be blocked from leaking electrolyte fluid due to barriers formed on the edges of the positive and negative portions 16, 20 of each electrode plate. The barrier may be a coating or other material, including frame material or even excess active material that may frame each positive and negative portion and contain the electrolyte. Alternatively, in a further embodiment, the insulator may have a diameter that is larger than the diameter of both the electrode assembly the container in which the spiral configuration resides, such that the insulator may form a barrier with the container wall and soak up leaking electrolyte fluid.

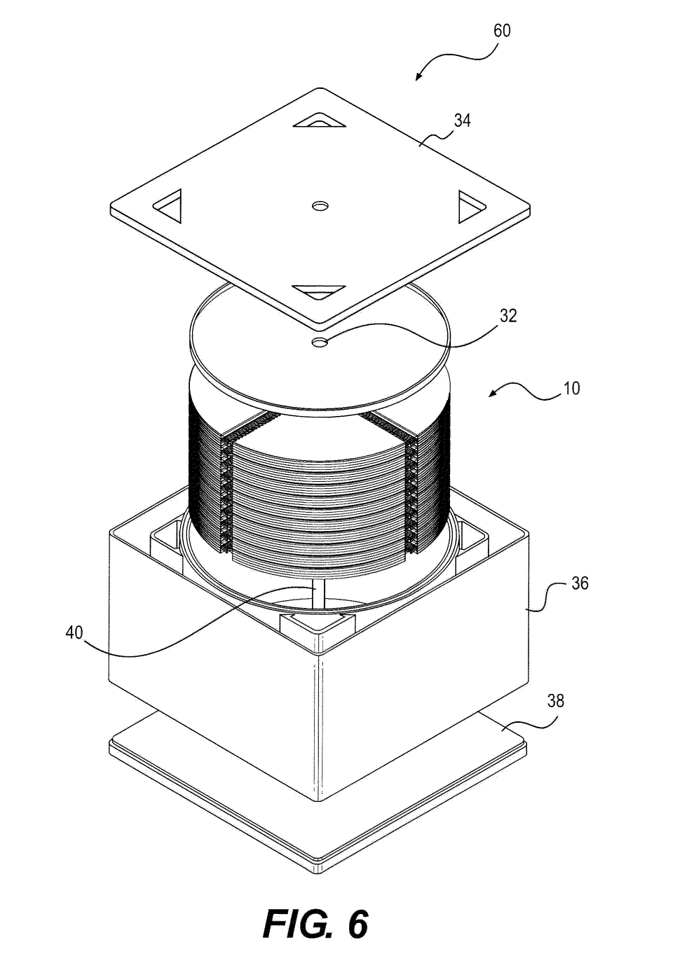

FIG. 6 depicts a lead-acid electrochemical module 60 according to a first embodiment of the present disclosure. The module 60 may include a top portion 34, a bottom portion 38, and a casing 36. Top and bottom portions 34, 38 may enclose the lead-acid electrochemical cell 10 within the casing 36. Casing may include an inner opening 40, which may be substantially the same diameter and height of the lead-acid electrochemical cell 10, such that the lead-acid electrochemical cell may be fully disposed within the casing 36 and covered by the top and bottom portions 34, 38. The module 60 may further include positive and negative terminals (not shown in FIG. 5) attached to the lead-acid electrochemical cell, such that the module may be used to provide energy and power.

As previously disclosed, the spiral configuration may connect electrode assemblies 12 in order to build voltage while maintaining a constant capacity of the lead-acid electrochemical cell. In a second, alternative embodiment, the electrode assemblies 12 may be stacked such that the voltage of the lead-acid electrochemical cell remains constant while building capacity. Accordingly, in this second embodiment, instead of the top plate 24D of one electrode assembly 12 being connected to the bottom plate 24a of another electrode assembly 12, the top and bottom plates of a single electrode assembly may be connected to complete the circuit. Each electrode assembly 12 may be connected to a tab 50, which may further be connected to a power bus assembly 500 for capacity building.

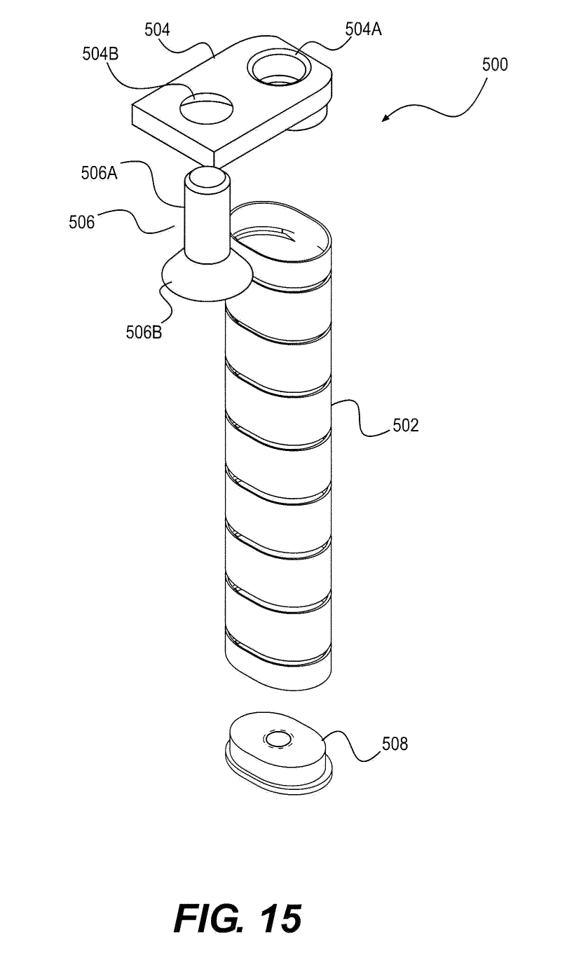

FIG. 15 illustrates the components of one embodiment of the power bus assembly 500. Power bus assembly 500 may include a power bus 502, a terminal 506, a connector piece 504, and a nut 508. In addition, as shown in FIG. 15, a bolt 510 may be connected to the connector piece 504, extend through the power bus 502, and attach to the nut 508. Bolt 510, when connected to the connector portion 502 and nut 508, may complete the connection of the bus system 500, which may thereby building capacity.

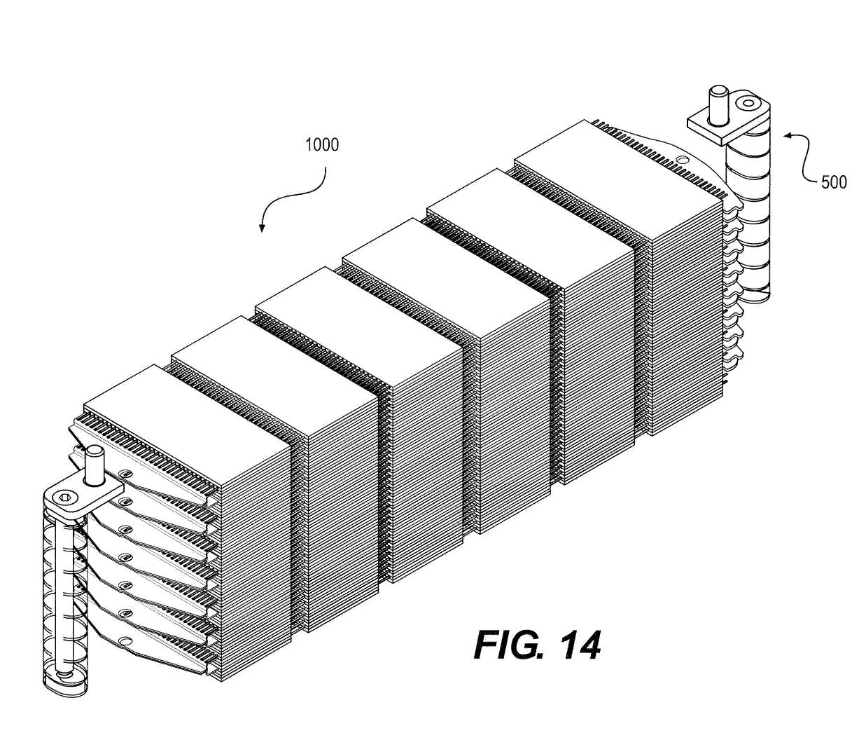

As shown in FIG. 15, connector 504 may include a first through-hole 504a and a second through-hole 504b formed therein. First through-hole 504a may connect to the bolt 510, and second through-hole 504b allow top portion of terminal 506a to extend there through. Terminal 506 may additionally include a bottom portion 506b, that may sit atop a top surface of the lead-acid electrochemical cell 1000. Top portion of terminal 506b may be an elongate member having a cross section that is substantially the same shape as the second opening 504b. The bottom portion of terminal may be flat. Alternatively, as shown if FIG. 14, the bottom portion of terminal 506b may have a concave inner surface.

Power bus 502 may include an elongate member having a length that is substantially the same as the height of the lead-acid electrochemical cell. Power bus 502 may further have slits disposed along its length, the slits being configured to receive connections from electrode plates, where the connections are solidified by compressing the power bus 502 in compression. Further, as shown in FIG. 15, a top surface of the power bus 502 may be in contact with a bottom surface of the connector piece 504, such that the connector piece 504 may carry current from the power bus 502 to the terminal 506. Consequently, power bus 502 may be made of any material known to those skilled in the art that allows for the carrying of current and the building of capacity.

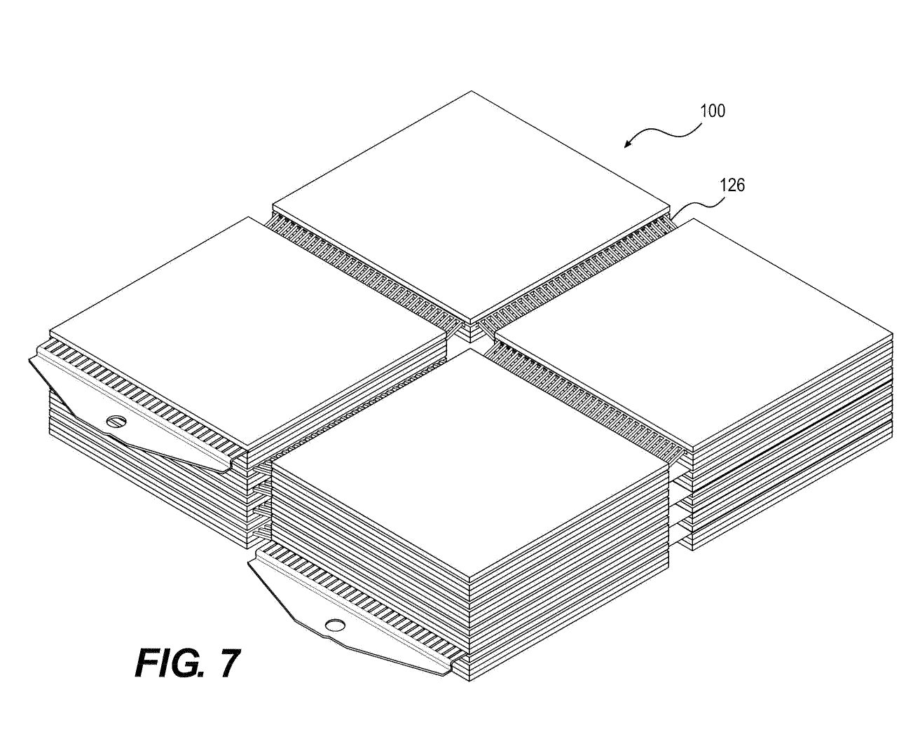

In a third embodiment of the present disclosure, the electrode plates may be rectangular in shape. The rectangular plates may be similar in area to the semi-circular electrode plates and may used to form similar-sized electrode assemblies and modules. For example, FIG. 7 shows a lead-acid electrochemical cell 100 according to a third embodiment of the present disclosure. The embodiment of FIG. 7 depicts stacking of rectangular electrode plates at a ninety degree angle relative to one another to form electrode assemblies, and connecting the electrode assemblies in the spiral configuration. As shown in FIG. 7, rectangular electrode plates may be connected to form electrode assemblies, and thereby a spiral configuration having a square cross-sectional shape.

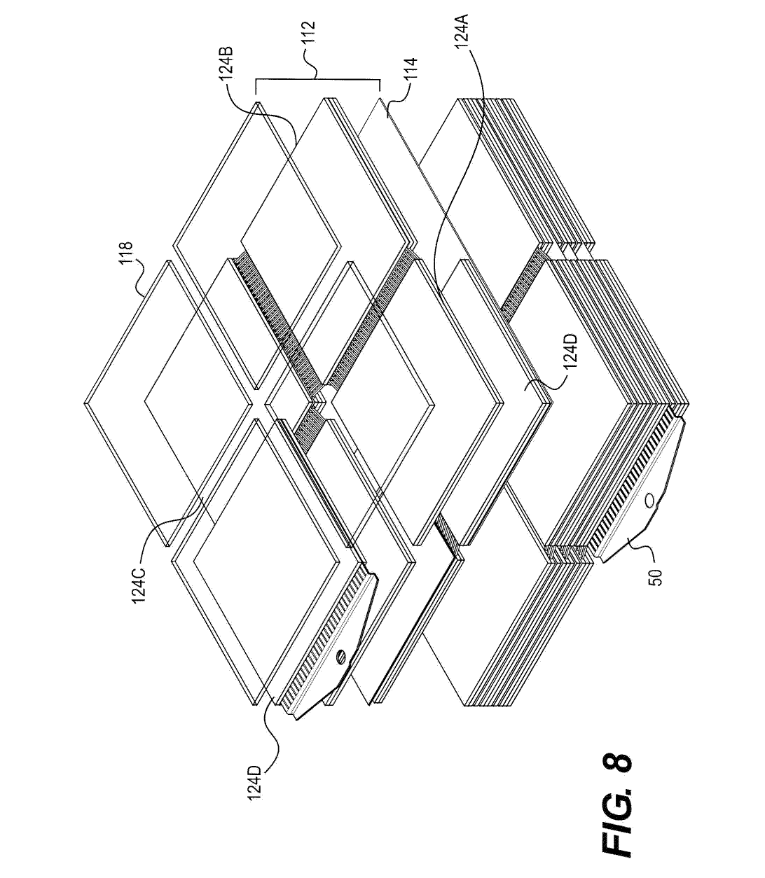

Similar to the electrode assembly 12 of FIG. 1, the electrode assembly 112 of FIG. 8 may include four rectangular electrode plates 124A-D. Each electrode plate 124A-D may include positive and negative portions connected by electrode connectors 126. In addition, each electrode plate may include pasting paper and separators 118. Further, as shown in FIG. 8, each electrode assembly 112 may be separated by an insulator 114, which may include the same cross-sectional shape as that of the electrode assembly 112, and while further may include a radial slit (not shown).

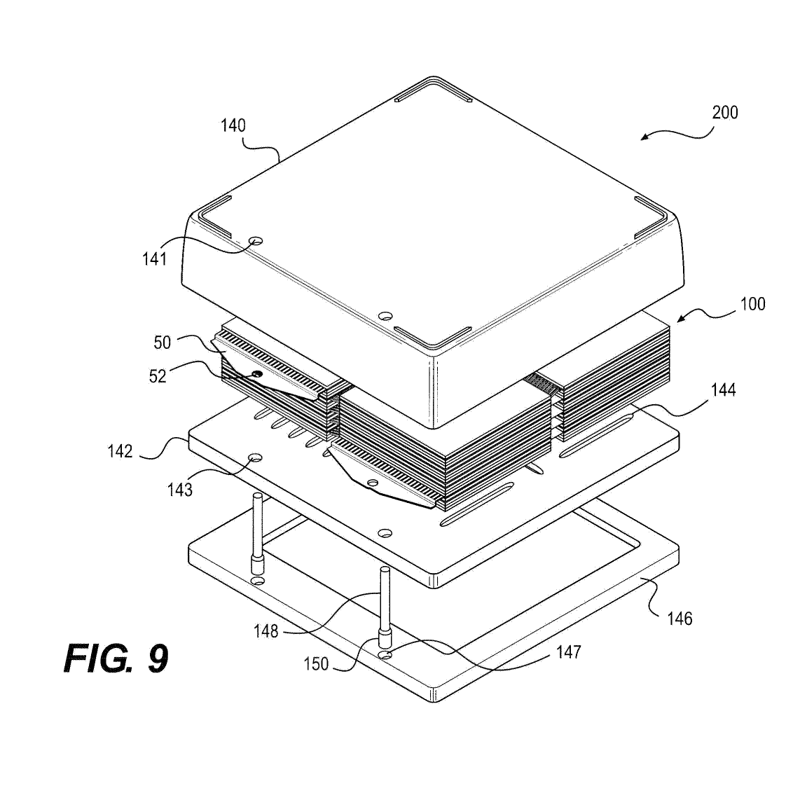

FIG. 9 depicts a lead-acid electrochemical cell module 200 according to a third embodiment of the present disclosure. Module 200 may include a casing 140, a slotted tray 142, and a drip tray 146. Slotted tray 142 may include a plurality of slots 144, which may allow excess electrolyte fluid to flow through the slotted tray 142 and into a collection portion on the drip tray 144. The drip tray 146 may include outer edges 145, which may be secured to inner edges of casing 140, such that casing 140 and drip tray 146 may enclose the lead-acid electrochemical cell 100 sitting atop slotted tray 142. Casing 140 and drip tray 146 may be secured via any means known to those skilled in the art. For example, in one embodiment, casing 140 and drip tray 146 may be held together via plastic ultrasonic welding.

The lead-acid electrochemical cell 100 may further include a tab 50 connected to a positive end and a tab 50 connected to a negative end of the spiral configuration. Tabs 50 may be securely connected to the positive and negative ends via any means known to those skilled in the art. For example, tabs 50 may be connected via soldering or ultrasonic welding. Tabs 50 may each contain a through-hole 52, which may allow for passage of posts 148. In addition, openings 141, 143, 147 in each of the casing 140, slotted tray 142, and drip tray 146, respectively, may also allow for posts 148 to pass there through.

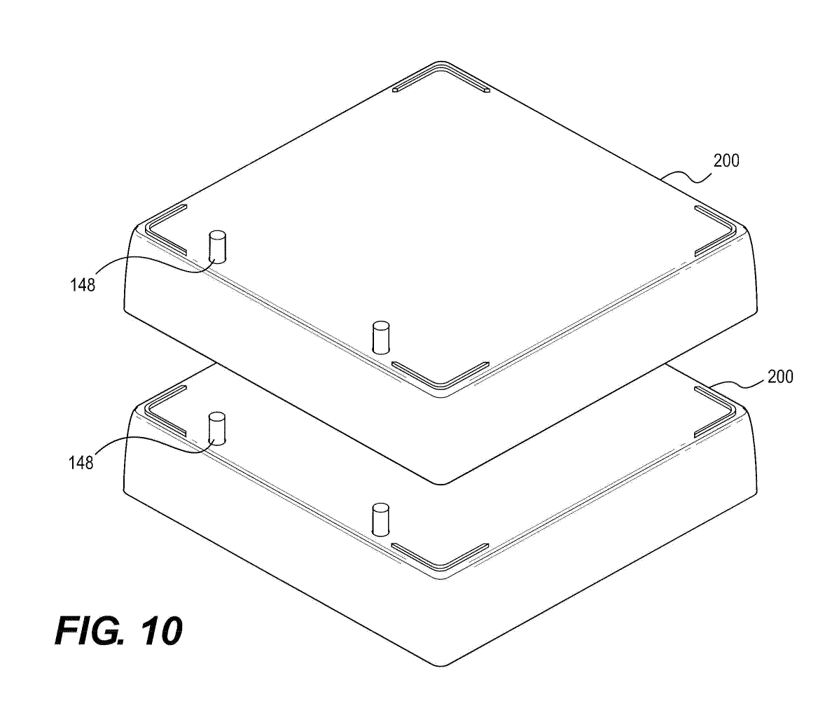

As shown in FIG. 10, posts 148 may extend out from respective openings 141 in the casing 140 so that they may act as positive and negative terminals for the lead-acid electrochemical cell module. Posts 148 may further include an end portion 150 with an opening therein. The opening in the end portion 150 may allow for individual lead-acid electrochemical cell modules 200 to be stacked upon one another (FIG. 10).

A fourth embodiment may employ the square electrode assembly 112 geometry of the third embodiment to build capacity at a constant voltage, rather than building voltage as in the third embodiment. Similar to that disclosed in relation to the second embodiment, this fourth embodiment may include connecting the free portion of the top plate 124D with the free portion of the first plate 124A in order to complete the circuit and therefore form a 12V electrode assembly 112. The electrode assemblies may 112 then be stacked and connected to the power bus assembly 500 in order to build capacity while maintaining a constant 12V of the lead-acid electrochemical cell. The fourth embodiment of the lead-acid electrochemical cell may further include a module that may be similar to that of the third embodiment.

The electrode plates may further be used form electrode assemblies, and thereby lead-acid electrochemical cell configurations, having a variety of cross-sectional shapes, in addition to circular and square. This variety of cross-sectional shapes may allow for stacked or spiral configurations of the lead-acid electrochemical cell to be placed in a variety of locations (e.g., in a vehicle) with little of no modification of the design of the location (e.g., vehicle frame) to accommodate the lead-acid electrochemical cell system. In these further embodiments, for example, each electrode assembly may include more than four plates. In addition, formation of these electrode assemblies may include stacking of the electrode plates linearly relative to one another, as well as at a ninety degree angle relative to one another. For example, in one embodiment, rectangular plates may be used to form a spiral configuration with a rectangular cross-section. Accordingly, there may be more electrode plates along the length of each electrode assembly than along the width.

In one embodiment, electrode plates may be oriented such that resulting electrochemical cells may provide volumetric efficiency in three orthogonal directions. For instance, the orientation of the electrochemical cells may provide improved dimensions in an x-direction, a y-direction, and/or a z-direction, where the xyz axes are not oriented in any particular way relative to an electrochemical cell casing. Alternatively, the orientation of the electrochemical cells may provide improved dimensions in an x-direction, a y-direction, and/or a z-direction, where the xyz axes are oriented relative to an electrochemical cell casing. As described above and below, the electrochemical cells may be united through ionic connections and a common current collector in such as way as to build voltage or capacity in the direction of one of the orthogonal directions x, y, z.

A fifth embodiment of the present disclosure may include formation of electrode plates into an electrode assembly, where the electrode assembly may include an L-shaped cross-section. Each electrode assembly may include electrode plates with positive and negative portions connected by electrode connectors. In addition, each electrode plate may include pasting paper and separators. Further, each electrode assembly may be separated by an L-shaped insulator having at least one slit to enable spiral connection of the L-shaped electrode assemblies. In addition, each electrode plate may further include means for mitigating shunt currents (e.g., hydrophobic coating on electrode connectors, hydrophobic framing of the plates, or and oversized insulator for soaking up electrolyte fluid).

The L-shaped lead-acid electrochemical cell may further include an L-shaped module. Similar to the circular and square modules, the L-shaped module may include a casing, slotted tray, and drip tray for collecting leaking electrolyte fluid. There may further be a tab connected to positive and negative ends of the L-shaped spiral configuration, such that the tabs may be connected to shafts that form terminals of the L-shaped lead-acid electrochemical cell.

An alternative, sixth embodiment of the L-shaped electrode assemblies may further include a capacity building geometry, similar to the other capacity-building embodiments disclosed herein. The L-shaped electrode assemblies in the sixth embodiment may each be connected in parallel, with each assembly terminating in a tab, with each of the respective tabs connected to the power bus assembly 500. The capacity-building L-shaped electrochemical cell may be housed within a module that is similar to the L-shaped module for the spiral configuration.

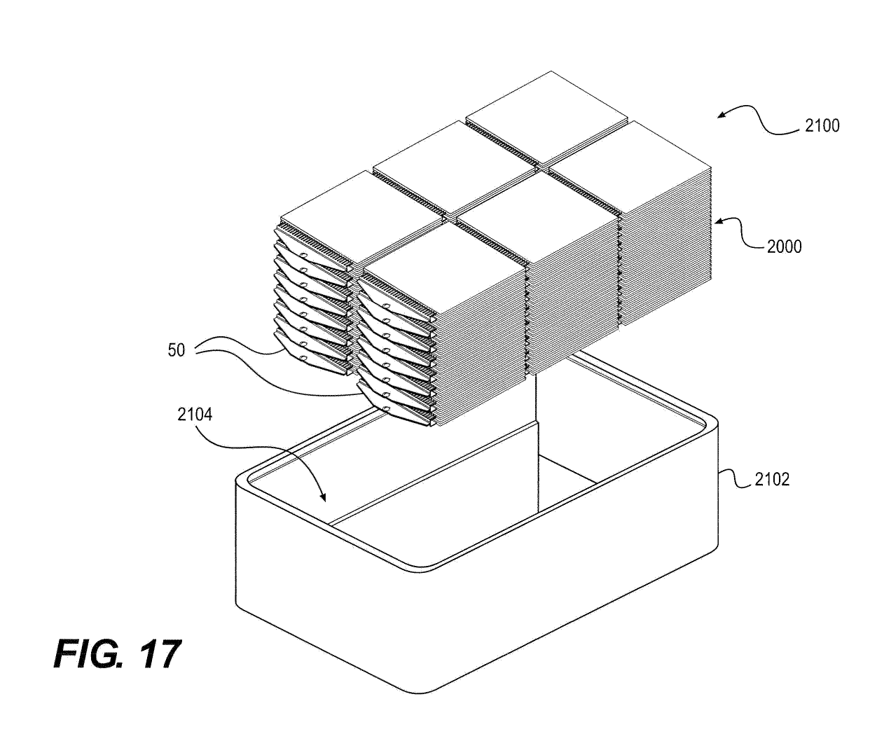

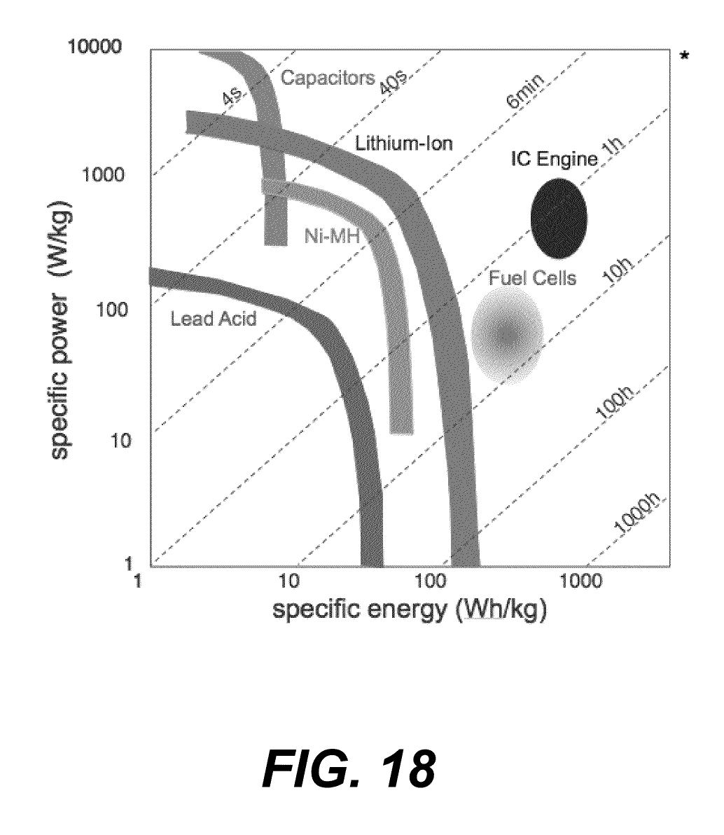

A seventh embodiment of the present disclosure may an electrode assembly having a U-shaped cross-sectional shape. The seventh embodiment may build voltage at a constant capacity, as disclosed herein. Alternatively, an eighth embodiment may include a U-shaped electrode assembly disposed to build capacity. FIG. 17 illustrates a lead-acid electrochemical cell 2000 according to an eighth embodiment of the present disclosure. The lead-acid electrochemical cell 2000 may include a plurality of electrode assemblies 2012 stacked, such that voltage may remain constant while capacity may be built. Each electrode assembly 2012 includes the U-shaped configuration, such that the lead-acid electrochemical cell 2000 may fit within a module that may include an intermediate separator 2104. The lead-acid electrochemical cell 2000 may further include a power bus 500 on each end to build capacity.

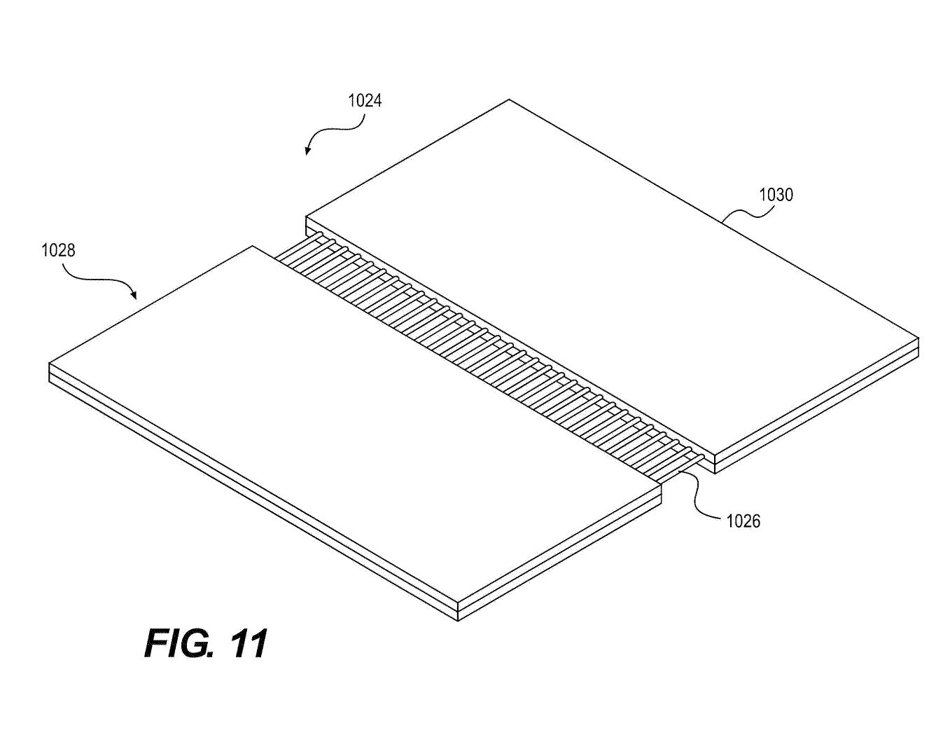

As a further alternative, the electrochemical cell may be configured in an elongated rectangular shape. FIG. 11 illustrates an electrode plate 1024 of a lead-acid electrochemical cell according to a ninth embodiment of the present disclosure. Similar to the electrode plates 24, 124 in FIG. 4A and FIG. 8, the electrode plate 1024 may include a first, positive portion 1028 and a second, negative portion 1030, with electrode connectors 1026 there between.

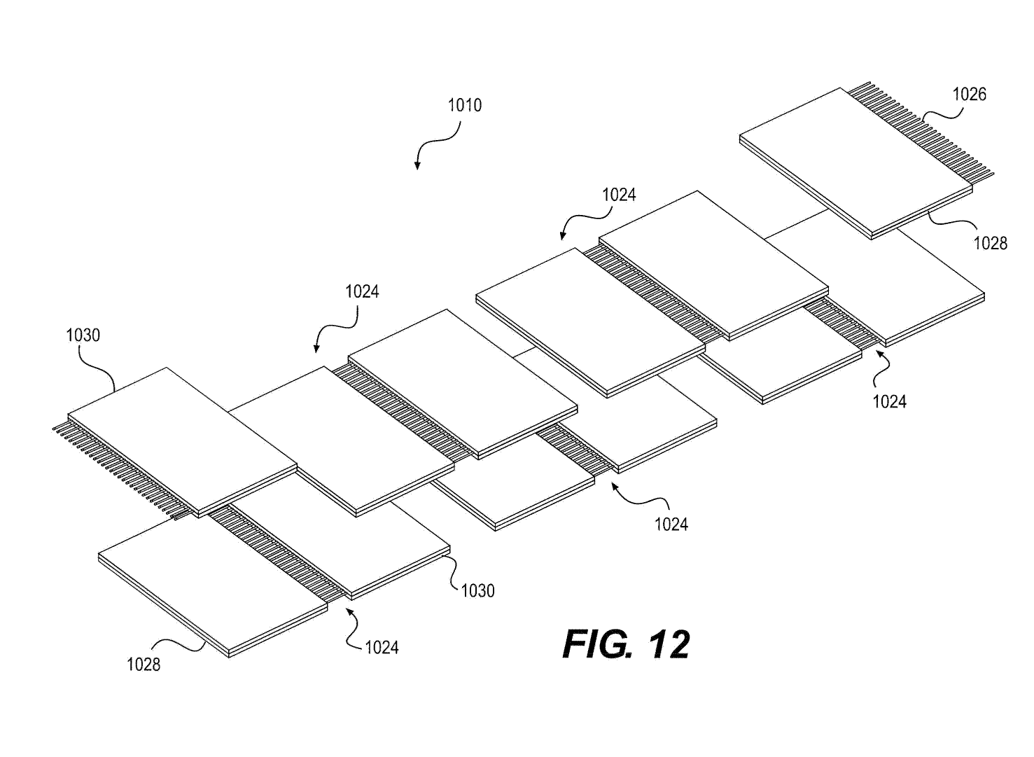

In the ninth embodiment, as shown in FIG. 12, the electrode assembly may be disposed in parallel in a capacity-building configuration. As shown in FIG. 12, electrode assemblies may be formed by aligning a desired number of electrode plates 1024, which may form the bottom portion of the electrode assembly. The top portion of the electrode assembly may be formed by aligning a positive portion 1028 of a top plate with a negative portion 1030 of a bottom plate, and so on. Separators may be located between each of the stacked positive and negative portions. In addition, formation of the electrode assembly may result in a free positive portion 1028 of a bottom electrode plate 1024 at one end, and a free negative portion 1030 of a bottom electrode plate 1024 at the opposite end. Individual negative and positive portions, respectively may be placed on these free ends in order to complete the circuit. Electrode assemblies may be formed of any desired voltage. For example, the electrode assembly 1010 of FIG. 12 may be 12 volt assembly.

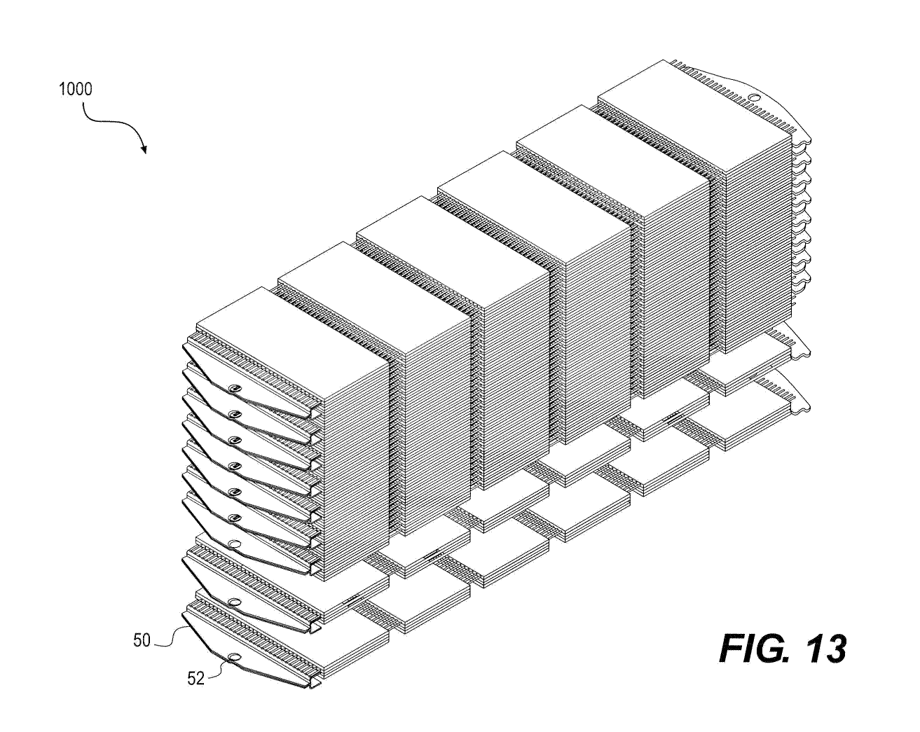

FIG. 13 illustrates a lead-acid electrochemical cell 1000, which may include the stacked electrode assemblies 1024 of FIG. 13. The lead-acid electrochemical cell 1000 may include tabs 50. Similar to the tabs 50 in the lead-acid electrochemical cell 100 of FIG. 7, each tab may include a through-hole 52 and may be connected via soldering or ultrasonic welding to a positive end and a negative end of each electrode assembly. FIG. 13, however, illustrates that tab 50 may be connected to two electrode assemblies, as opposed to only one.

FIG. 14 further illustrates that each end of the lead-acid electrochemical cell 1000 may be connected to a power bus assembly 500, which may allow for the individual electrode assemblies 1024 to be connected in parallel in order to build capacity of the lead-acid electrochemical cell 1000.

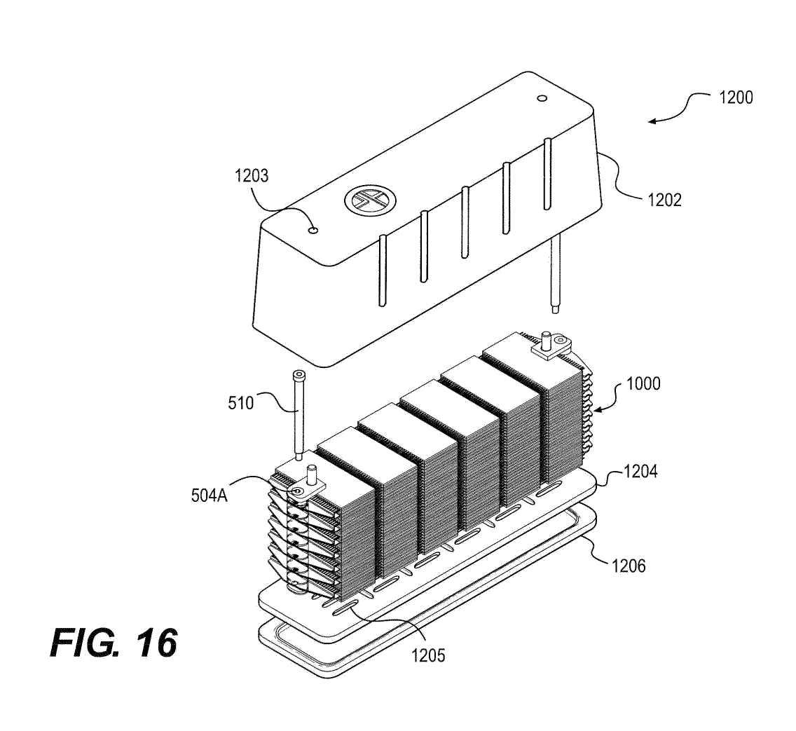

FIG. 16 illustrates a lead-acid electrochemical cell module 1200 including the lead-acid electrochemical cell 1000 of FIG. 14. Similar to the lead-acid electrochemical cell module 200 of FIG. 9, the lead-acid electrochemical cell module 1200 may include a casing 1202, a slotted tray 1204 with a plurality of slots 1205, and a drip tray 1206 for collecting electrolyte fluid that seeps through the slots 1205 of the slotted tray. The casing 1202, slotted tray 1204, and drip tray 1206 may include a length, width, and height that are slightly larger than the dimensions of the lead-acid electrochemical cell 1000, such that the casing 1202 and drip tray 1206 may completely enclose the lead-acid electrochemical cell 1000. Further, similar to the module 200 of FIG. 10, the casing 1202 and the drip tray 1206 may be held together via any process known to those skilled in the art, including, but not limited to plastic ultrasonic welding.

Other embodiments of the disclosure will be apparent to those skilled in the art from consideration of the specification and practice of the invention disclosed herein. For example, various elements or components of the disclosed embodiments may be combined with other elements or components of other embodiments, as appropriate for the desired application. Thus, it is intended that the specification and examples be considered as exemplary only, with a true scope and spirit of the disclosure being indicated by the following claims.

What is claimed is:

1. An electrochemical storage device, comprising:
first and second electrochemical cells;
said first and second electrochemical cells each comprising an anode and a cathode;
said anode of said first electrochemical cell disposed opposite said cathode of said first electrochemical cell, with a separator disposed between said anode and said cathode wherein said anode and cathode are electrically insulated and in communication through an ionically conductive medium adsorbed in said separator;
said anode of said first electrochemical cell and said cathode of said second electrochemical cell disposed on a common current collector;
said first and second electrochemical cells are electrically connected and insulated from ionic conduction;
said ionic separation of said first and second electrochemical cells mitigating shunt currents;
said electrochemical cells being disposed to provide volumetric efficiency in three orthogonal directions; and
said first and second electrochemical cells disposed in a common casing.

2. The device of claim 1, wherein the first and second electrochemical cells, and any additional electrochemical cells of the device, are disposed to build voltage in any of said three orthogonal directions.

3. The device of claim 1 wherein the first and second electrochemical cells, and any additional electrochemical cells of the device, are disposed to build capacity in any of said three orthogonal directions.

4. The device of claim 1, further comprising said current collector providing substantially uniform current collection granting uniform current density.

5. The device of claim 1, further comprising a hydrophobic coating disposed on the portion of the common current collector between said anode and said cathode.

6. The device of claim 1, further comprising a physical barrier to ionically insulate said first and second electrochemical cells.

7. The device of claim 1, further comprising one positive and one negative terminal connection.

8. The device of claim 1, further comprising an insulation frame for disposing anodes and cathodes of two or more electrochemical cells in substantially the same plane.

9. An electrochemical storage device, comprising:
a first and second electrochemical cells;
said first and second electrochemical cells each comprising an anode and a cathode;
said anode of said first electrochemical cell disposed opposite to said cathode of said first electrochemical cell, with a separator disposed between said anode and said cathode;
said anode of said first electrochemical cell and said cathode of said second electrochemical cell disposed on a common current collector;
said first and second electrochemical cells are ionically insulated and electrically connected;
said ionic insulation of said first and second electrochemical cells mitigating shunt current;
an insulation frame for disposing said anodes and said cathodes of two or more electrochemical cells in substantially the same plane; and
said first and second electrochemical cells disposed in a common casing.

10. The device of claim 9, wherein the first and second electrochemical cells, and any additional electrochemical cells of the device, are disposed to build voltage in any of said three orthogonal directions.

11. The device of claim 9, wherein the first and second electrochemical cells, and any additional electrochemical cells of the device, are disposed to build capacity in any of said three orthogonal directions.

12. The device of claim 9, wherein said anodes and cathodes are substantially radially-shaped segments disposed in said common frame.

13. The device of claim 9, wherein said anodes and cathodes are substantially square-shaped segments disposed in said common frame.

14. The device of claim 9, wherein said anodes and cathodes are substantially rectangular-shaped segments disposed in said common frame.

15. The device of claim 9, wherein said common current collector is substantially shaped as a circular sector.

16. The device of claim 9, further comprising said frame disposed in substantially x and y directions, wherein voltage is increased in the z direction, by disposing additional electrochemical cells in a spiral configuration, maintaining constant capacity.

17. The device of claim 9, further comprising said frame disposed in substantially x and y directions, wherein capacity is increased in the z direction, by connecting in parallel additional strings of electrochemical cells having the same voltage.

18. The device of claim 9, further comprising said frame disposed in substantially x and y directions, wherein capacity and voltage are increased in the z direction, by adding multiple spiral strings of electrochemical cells connected in series.

19. The device of claim 9, further comprising said frame disposed in substantially x and y directions, wherein capacity and voltage are increased in the z direction, by adding multiple spiral strings of electrochemical cells connected in parallel.

20. The device of claim 9, further comprising said frame disposed in substantially x and y directions, wherein capacity and voltage are increased in the z direction, by adding multiple spiral strings of electrochemical cells connected in parallel and multiple spiral strings of electrochemical cells connected in series.

21. The device of claim 9, further comprising said current collector providing substantially uniform current density.

22. The device of claim 9, further comprising a hydrophobic coating disposed on the portion of the current collector between said anode and said cathode.

23. The device of claim 9, further comprising a physical barrier to ionically insulate said first and second electrochemical cells.

24. The device of claim 9, further comprising one positive and one negative terminal connection.

25. An electrochemical storage device, comprising:
a first and second electrochemical cells;
said first and second electrochemical cells each comprising an anode and a cathode;
said anode of said first electrochemical cell disposed opposite said cathode of said first electrochemical cell, with a separator disposed between said anode and said cathode;
said anode of a said first electrochemical cell and said cathode of said second electrochemical cell disposed on a common current collector;
said first and second electrochemical cells are ionically insulated and electrically connected;
said ionic insulation of said first and second electrochemical cells mitigating shunt current;
said anodes and cathodes are configured in substantially radially-shaped sections; and
said first and second electrochemical cells disposed in a common casing.

26. The device of claim 25, wherein the first and second electrochemical cells, and any additional electrochemical cells of the device, are arranged to build voltage in any of said three orthogonal directions.

27. The device of claim 25, wherein said radially-shaped sections are disposed in a common frame.

28. The device of claim 25, wherein said radially-shaped sections are disposed in a spiral configuration.

29. The device of claim 25, further comprising said anode and cathode disposed in substantially x and y directions, wherein voltage is increased in the z direction, by disposing additional electrochemical cells in a spiral configuration, maintaining constant capacity.

30. The device of claim 25, further comprising said anode and cathode disposed in substantially x and y directions, wherein capacity is increased in the z direction, by connecting in parallel additional strings of electrochemical cells having the same voltage.

31. The device of claim 25, further comprising said anode and cathode disposed in substantially x and y directions, wherein capacity and voltage are increased in the z direction, by adding multiple spiral strings of electrochemical cells connected in series.

32. The device of claim 25, further comprising said anode and cathode disposed in substantially x and y directions, wherein capacity and voltage are increased in the z direction, by adding multiple spiral strings of electrochemical cells connected in parallel.

33. The device of claim 25, further comprising said anode and cathode disposed in substantially x and y directions, wherein capacity and voltage are increased in the z direction, by adding multiple spiral strings of electrochemical cells connected in parallel and multiple spiral strings of electrochemical cells connected in series.

34. The device of claim 25, further comprising said current collector providing substantially uniform current density.

35. The device of claim 25, further comprising a hydrophobic coating disposed on the portion of the current collector between said anode and said cathode.

36. The device of claim 25, further comprising a physical barrier to ionically isolate said first and second electrochemical cells.

37. The device of claim 25, further comprising one positive and one negative terminal connection.
